(19) United States
(12) Patent Application Publication
(10) Pub. No.: US 2005/0191436 A1
(43) Pub. Date: Sep. 1, 2005

(54) Laser-marked body ornaments and method of manufacturing the same

(76) Inventors: Jared Ross Van Orman, Springville, UT (US); Nicole Van Orman, Springville, UT (US)

Correspondence Address: Angus C. Fox, III, 4093 N. Imperial Way, Provo, UT, 84604-5386, US

(21) Appl. No.: 10/789,104

(22) Filed: Feb. 27, 2004

(51) Int. Cl. B05D 3/00

(52) U.S. Cl. 427/553

(57) ABSTRACT

A method of manufacturing a body ornament, such as a bracelet, includes the steps of coating a piece of sheet metal with a metal marking spray, such as LMM-6000; subjecting the coated piece of sheet metal to a computer-controlled laser, whereby heat generated by the laser causes selected regions of the metal marking spray to react with the underlying sheet metal to form a metal-ceramic design; removing any remaining metal marking spray; and bending the piece of sheet metal to a desired three-dimensional shape. The piece of sheet metal marked with the metal-ceramic design may be formed by bending into a single body ornament, or it may be cut into multiple pieces, each of which may be formed by bending into individual body ornaments. The sheet metal is stainless steel, aluminum, tin, copper, brass, chromed steel, titanium, niobium, tantalum, silver, gold, palladium, platinum or pewter.

### BACKGROUND OF THE INVENTION

1. Field of the Invention

This invention relates to body ornaments and jewelry and, more particularly, to body ornaments, such as sheet metal bracelets that are bent or formed following a laser etching process that creates a metal-ceramic coating thereon.

2. Description of the Prior Art

During the last two decades of the twentieth century and during the early twenty-first century, methods have been developed for the laser marking of metals, plastics, ceramics and glasses. One method of marking metals with a laser involves a vaporization process, wherein a laser is used to remove or ablate metal from the surface along the travel path of the laser. The resultant marking comprises engraved or indented portions which provide three-dimensional contrast to the surface of the metal. Alternatively, laser marking of metals may be achieved by annealing a selected portion of the metal surface to provide areas of contrasting color. In this case, instead of removing metal from the surface, the laser is used to heat the surface of the metal to an annealing temperature which typically results in darkening of the annealed regions.

Plastics are typically laser marked by either changing the color of the plastic or engraving the surface of the plastic along the travel path of the laser. The color of the plastic is typically changed by localized melting and re-solidification of the plastic. In contrast, engraving is achieved by vaporization and removal of the plastic. Both methods have been used to mark plastic packages housing integrated circuits. Plastic laser engraving methods can be used to remove a surface layer of the plastic to reveal an underlying layer of contrasting color. Such a process is disclosed in U.S. Pat. No. 5,061,341 to Kildal et al.

Laser marking of ceramics and glasses has also been investigated, as a replacement for conventional etching, engraving and glazing techniques. For example, laser marking of glass has been achieved by ablation techniques as disclosed in U.S. Pat. No. 4,327,283 to Heyman et al. and U.S. Pat. No. 4,515,867 to Bleacher et al. In the disclosed methods, two coating layers are applied to a glass substrate, and the top layer is removed by the laser to reveal the contrasting underlayer.

Another technique for laser marking ceramics and glasses is disclosed in U.S. Pat. No. 4,769,310 to Gugger et al. and U.S. Pat. No. 5,030,551 to Herren et al. In this technique, a glaze having a radiation-sensitive additive comprising an inorganic pigment or titanium dioxide is deposited and fired on the surface of a ceramic or glass substrate. A laser beam is then used to irradiate the fired surface layer to thereby change the color of the surface layer in the areas of irradiation.

A technique for laser marking metals is disclosed in U.S. Pat. No. 5,855,969 to Robertson. A layer of silicone resin or phenyl-substituted resin, pigmented with TiO₂ or Al₂O₃ is formed on the planar surface of a metal plate. Such coatings are cured at elevated temperature so as to leave residual methyl and/or phenyl groups unbound or free. The Robertson technique employs a raster-scanning infrared-energy-emitting carbon dioxide (CO₂) laser that scans in a Y-axis direction and moves in an X-axis direction to direct energy on the surface of the resin layer. When the resin layer is impinged on by the focused energy of the CO₂ laser, the residual free methyl and/or phenyl groups are converted to either free carbon or to silicon carbide, both of which are black compounds. The free carbon is protected from oxidation loss by its presence in a dense translucent siloxane matrix. The silicon carbide is inherently more resistant to oxidation at high temperatures.

A method for marking glass, ceramic, metal and plastic substrates is disclosed in U.S. Pat. No. 6,238,847 to Axtell, Ill., et al. A marking material, which comprises glass frit or precursors thereof, inorganic pigments or precursors thereof, inorganic pigments or precursors thereof, silicates, metal oxides, sulfides, nitrides and carbides, organometallic materials or metal powders, is applied to the surface of the substrate, followed by irradiation of a portion of the marking material to form a permanent marking on the substrate. The marking method can be performed quickly and produces permanent marks of high resolution and contrast without damage to the substrate.

An additional technique for marking a variety of materials, including metals, glass, ceramics and plastics is disclosed in U.S. Pat. No. 6,503,310 to Sullivan. A laser marking material is formulated from at least one pigment, such as titanium dioxide (TiO₂), that is strongly discolored by laser light, and at least one fixing agent such as bismuth trioxide (Bi₂O₃), antimony oxide, lead oxide, vanadium pentoxide, molybdenum trioxide, an alkaline earth silicate, or an alkaline or an alkaline-earth aluminosilicate, that preferably melts below about 1,300° C. After the marking material is applied to the surface of a substrate, a selected portion of the marking material is irradiated with a laser beam to adhere the irradiated marking material to the substrate and to form a permanent marking thereon. Suitable lasers include neodymium-doped yttrium aluminum garnet (Nd:YAG) lasers, carbon CO₂ lasers, diode lasers, and excimer lasers.

Each of the patents cited above is incorporated herein by reference.

### SUMMARY OF THE INVENTION

A method of manufacturing a body ornament or item of jewelry (collectively, jewelry), such as a bracelet or money clip, includes the steps of coating a piece of sheet metal of generally uniform thickness with a metal marking spray, such as Cermark® LMM-6000 produced by Cerdec Corporation of Washington, Pennsylvania; subjecting the coated piece of sheet metal to a computer-controlled laser beam, whereby heat generated by the laser causes selected regions of the metal marking spray to react with the underlying sheet metal to form a metal-ceramic design; removing any remaining metal marking spray; and bending the piece of sheet metal to a desired three-dimensional shape. The piece of sheet metal marked with the metal-ceramic design may be formed by bending into a single body ornament, or it may be cut into multiple pieces, at least some which are formed by bending into individual body ornaments. The sheet metal is stainless steel, aluminum, tin, copper, brass, chromed steel, titanium, niobium, tantalum, silver, gold, palladium, platinum or pewter.

For a preferred embodiment of the invention, a raster-scanning infrared-energy-emitting carbon dioxide (CO₂) laser system is employed. The laser system scans in a Y-axis direction and moves in an X-axis direction to direct energy on the surface of the metal-marking-spray-covered metal. Also for a preferred embodiment of the invention, the individual pieces which are formed by bending, are deburred after they are cut. For a preferred embodiment of the process, the size of the sheet metal piece is finalized before it is laser marked, so that the sheet metal piece can be deburred, the edges smoothed and or rounded, and at least the major surfaces of the piece either polished or brushed prior to the laser marking step. If the deburring, smoothing, rounding, polishing or brushing were to take place after the laser marking step, the laser marked design may be at least partially removed by the finishing process.

Although lasers, such as a YAG laser, can darken a wider variety of materials than a CO₂ laser, a YAG laser typically has a much shorter life than a CO₂ laser and, hence, may not be suitable for a production environment. Sealed CO₂ laser units generally have an operating life expectancy in excess of 10,000 hours.

### BRIEF DESCRIPTION OF THE DRAWINGS

FIG. 1 is a side elevational view of a bare, sheet metal substrate.

FIG. 2 is a side elevational view of the sheet metal substrate of FIG. 1 following the formation of a metal marking layer thereon;

FIG. 3 is a side elevational view of the marking layer coated sheet metal substrate of FIG. 2 following selective irradiation by a laser beam;

FIG. 4 is a side elevational view of the sheet metal substrate of FIG. 3 following the removal of non-irradiated portions of the metal marking layer;

FIG. 5 is a block perspective diagram of a raster scanning laser system having a movable optics table and a metal strip being scanned and marked;

FIG. 6 is a top plan view of metal strip from which five individual strips will be cut in preparation for the inventive process;

FIG. 7 is a top plan view of an individual metal strip after singulation;

FIG. 8 is a top plan view of the individual metal strip of FIG. 7 after rounding of the corners;

FIG. 9 is a cross-sectional view taken through section line 9-9 of FIG. 8 and showing the rounding of the top and bottom lateral edges;

FIG. 10 is a side elevational diagram of a slip roller device in which a marked metal strip has been inserted;

FIG. 11 is a side elevational view of the metal strip formed by the slip roller process of FIG. 10; and

FIG. 12 is a perspective view of a bracelet that has been laser marked with a name and a graphic design.

### DETAILED DESCRIPTION OF THE INVENTION

A method of manufacturing a body ornament or item of jewelry (collectively, jewelry), such as a bracelet or money clip, includes the steps of coating a piece of sheet metal of generally uniform thickness with a metal marking spray, such as Cermark® LMM-6000 produced by Cerdec Corporation of Washington, Pennsylvania; subjecting the coated piece of sheet metal to a computer-controlled laser beam, whereby heat generated by the laser causes selected regions of the metal marking spray to react with the underlying sheet metal to form a metal-ceramic design; removing any remaining metal marking spray; and bending the piece of sheet metal to a desired three-dimensional shape. The piece of sheet metal marked with the metal-ceramic design may be formed by bending into a single body ornament, or it may be cut into multiple pieces, at least some which are formed by bending into individual body ornaments. The sheet metal is stainless steel, aluminum, tin, copper, brass, chromed steel, titanium, niobium, tantalum, silver, gold, palladium, platinum or pewter. The invention will now be described with reference to the attached drawing figures.

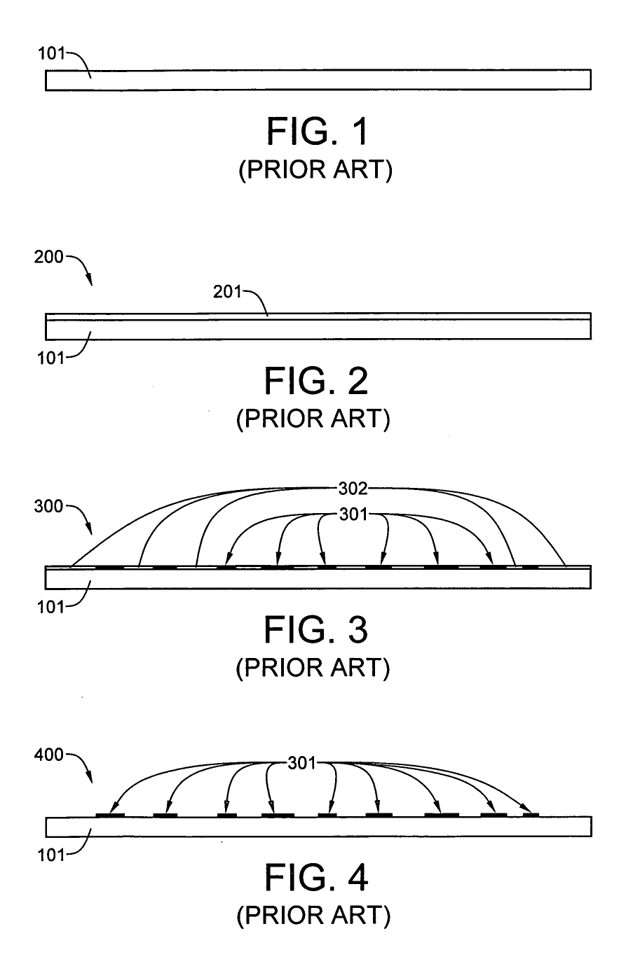

Referring now to FIG. 1, a metal substrate 101 is provided having appropriate length, width and thickness. For a bracelet, the substrate is a sheet metal strip having a width, depending on the application (i.e., age and sex of the intended wearer), within a range of about 0.5 inch to about 1.125 inch, a length, also depending on the application, within a range of about 4.5 inches to about 6.75 inches, and a thickness within a range of about 0.0396 inch to about 0.0516 inch. Theses dimensions are meant to be only illustrative and other dimensions may be used to implement the invention.

Referring now to FIG. 2, the metal substrate 101 is coated with a metal marking layer 201, resulting in a metal marking compound coated substrate 200. For a preferred embodiment of the invention, the metal marking layer contains molybdenum trioxide, at least one vanadium compound, mica group minerals, and crystalline silica. Cerdec Corporation, a subsidiary of Ferro corporation produces several metal marking layer compounds which may be utilized to implement the present invention. Marketed under the trademark Cermark, the compounds include formulations identified as LMM-6000, RD-6038, RD-6012, and LMM-5001. Certain of these compounds are sprayed on the substrate 101 as a ethanol-based solution. Others may be silk screened on the substrate.

Referring now to FIG. 3, selected regions of the coated substrate 200 are subjected to a raster scanning laser beam (not shown in this drawing figure). The heat energy of the laser beam has caused the dark regions 301 to permanently adhere to the substrate 101. As used herein, the term “adhere” is used to designate any permanent means of attachment of the irradiated marking material to the substrate. For example, the irradiated marking material may be adhered to the surface of the substrate by sintering the marking material to the substrate, fusing the marking material to the surface of the substrate, diffusing at least a portion of the marking material into the substrate, reacting the marking material with the substrate and the like. As used herein, the term “permanent marking” means a non-temporary marking which, for example, possesses relatively high wear resistance, corrosion resistance and/or facing resistance. It will be noted that at this stage of the process, non-irradiated regions of the marking layer 302 still cover the substrate 101.

Referring now to FIG. 4, the non-irradiated regions of the marking layer 302 have been removed by a solvent wash. Only the permanent markings 301 remain on the substrate 101. The marked substrate 400 is now ready for forming into a desired shape.

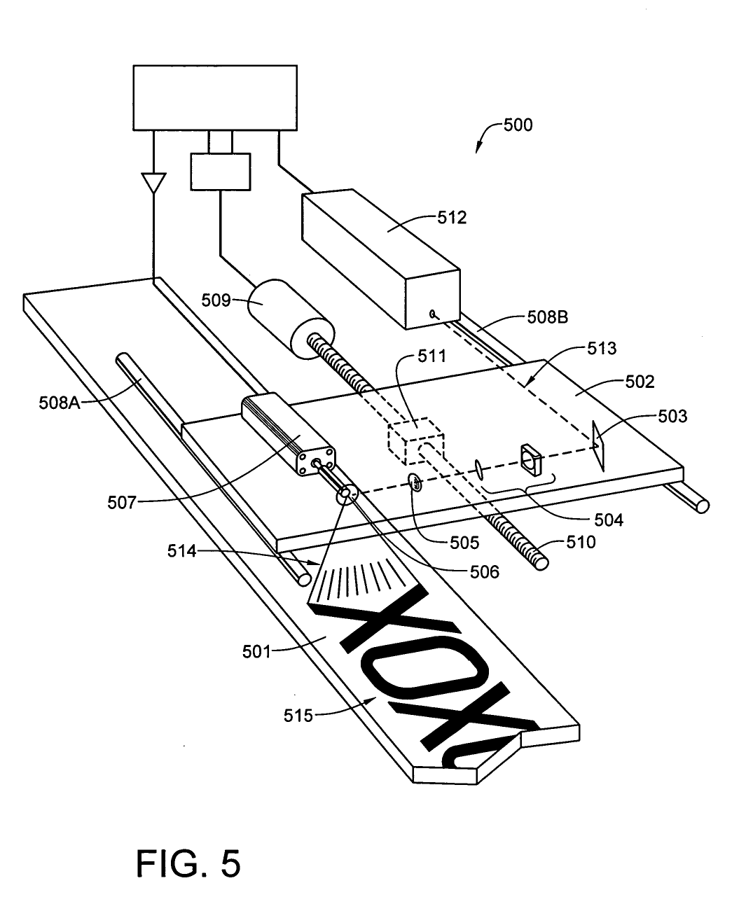

Referring now to FIG. 5, a raster-scanning laser system 500, that scans in a Y-axis direction and moves in an X-axis direction as it directs energy on a planar major surface of the metal-marking-spray-covered laminar metal strip 501. This particular system has an optics platform 502 that moves relative to the item being marked, which remains affixed to a stationary marking table (not shown). The optics platform 502 consists of corner mirror 503, an optional beam expander assembly 504, a focusing lens 505, a Y-axis deflecting mirror 506, and a galvanometer 507. The optics platform 502 rides on rails 508A and 508B, and is moved in the X direction by a stepper motor 509, which is connected to ball screw 510, which passes through a ball nut 511. The ball nut 511 is connected to the under side of optics platform 502. In this configuration, the stepping action of the stepper motor 509 advances the optics platform 502 a distance per step of, for example, 0.3 mm (about 0.012 inch). The laser energy source 512, can itself remain stationary and spaced-apart from optics platform 502, since the laser beam 513 passes the marking energy to the moving optics platform 502 via the mirror 503. Marking is done as the galvanometer-deflected beam 514 traverses over an unmarked zone on the metal-marking-spray-covered laminar metal strip 501. It will be noted that a design 515 consisting of alternating Xs and Os is being marked on the strip 501. The mirror 503 is used to fold the beam and, thereby, reduce the size of the instant marking system. The laser beam 513 is, thus reflected by the mirror 503 and focused by the lens 505 so that a spot is optimally focused on the sheet metal substrate, after the beam is deflected by Y-scanning galvanometer mirror 506. The optional beam expander assembly 504 will reduce the focusing spot size and produce higher power density blackening. Both lenses in optional beam expander assembly 504 and the focusing lens 505 must be fabricated from infrared transmissive material, such as, for example, ZnSe. Deflection of beam 513 is controlled by galvanometer 507. Deflection of the scanning arc and the on/off control of the laser 512 is sequenced by control electronics 516 which provides analog signal 517 which is amplified by amplifier 518 (with optional servo feedback) to control the galvanometer 507 and digital signal 519 which enables the laser 512 lasing as is required by the image to be marked. A CO₂ laser is preferred because of its long average useful life of more than 10,000 hours. A preferred laser system has a 25 watt laser beam. It should be understood that other types of laser systems may be substituted for the one that is shown in the drawing, and that the system of FIG. 5 is meant to be merely illustrative.

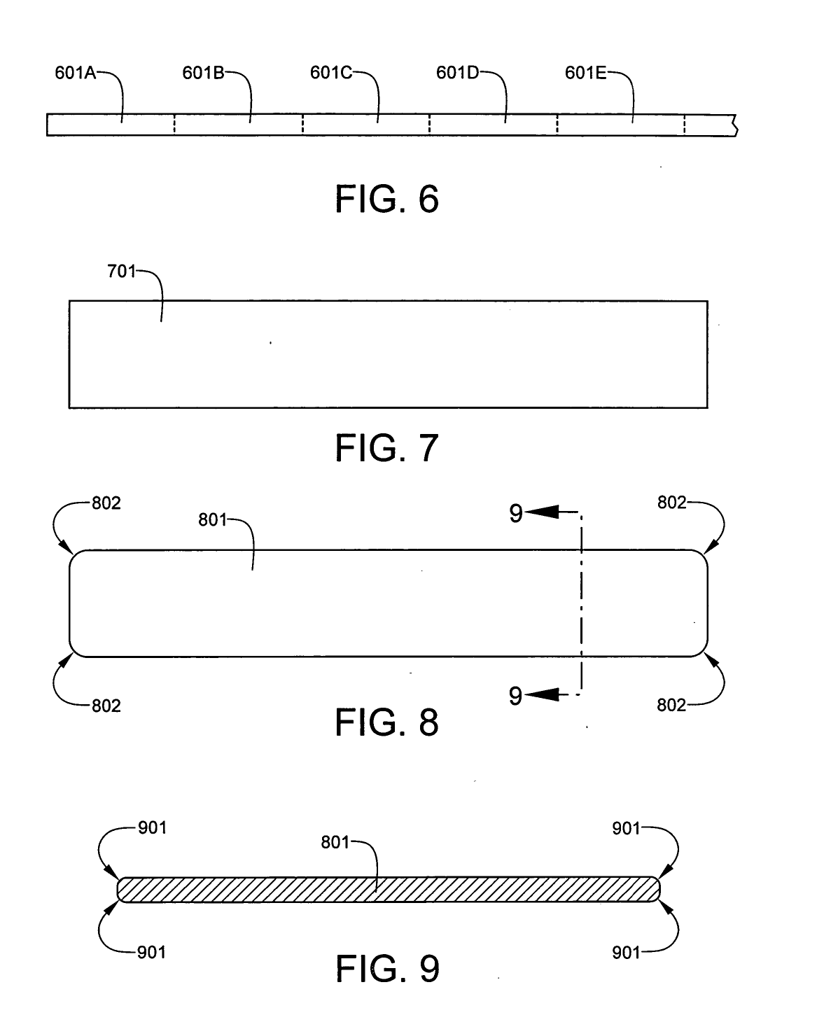

Referring now to FIG. 6, the process begins by preferably cutting a long strip of sheet metal of an appropriate width and thickness into pieces having a desired length. In the segment visible in this drawing figure, five full-length pieces 601A, 601B, 601C, 601D and 601E may be cut.

Referring now to FIG. 7, a single sheet metal strip 701 is shown prior to deburring, rounding the edges, rounding the side edges, as well as polishing or brushing.

Referring now to FIG. 8, the corners 802 of metal strip 701 have been rounded to create an intermediate product 801.

Referring now to FIG. 9, this cross-sectional view shows how the longitudinal side edges 901 of the intermediate product 801 have been rounded to prevent them from cutting the wearer. The lateral side edges may be rounded in a similar manner. At this stage of the process, the intermediate product 801 is now ready for the application of a laser marking layer and irradiation by the laser beam of a raster-scanning laser system. These steps are shown and described above with reference to drawing FIGS. 1 to 5.

Referring now to FIG. 10, the laser marked metal strip 501 is passed through a slip roller which comprises an upper roller 1001U, a lower roller 1001L and a back roller 1001B. The distance between the upper roller 1001U and the lower roller 1001L can be adjusted for the thickness of the metal strip 501. The radius of the bend can be adjusted by moving the back roller 1001B in a direction shown by the double arrows that is superimposed thereon.

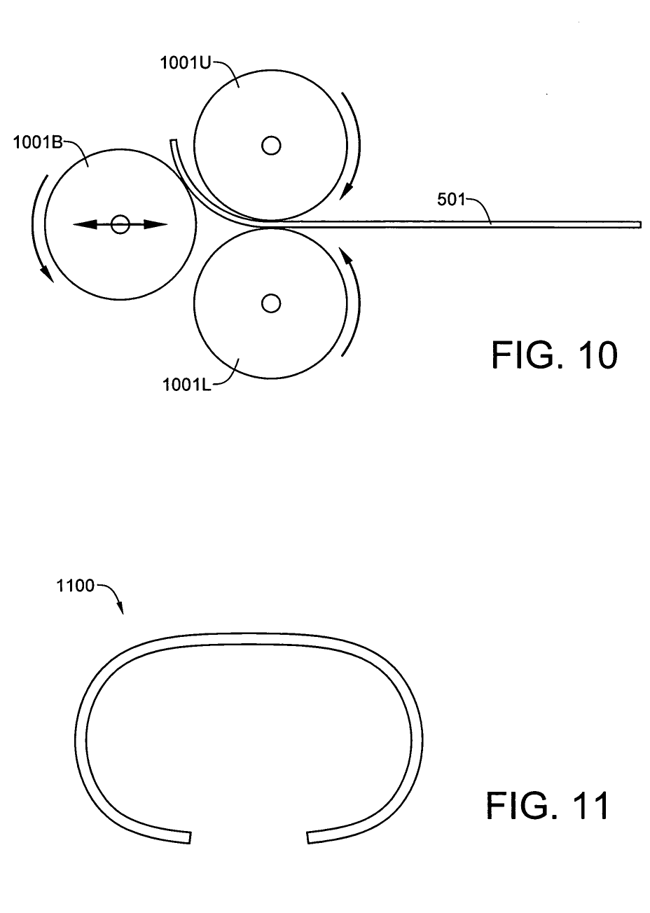

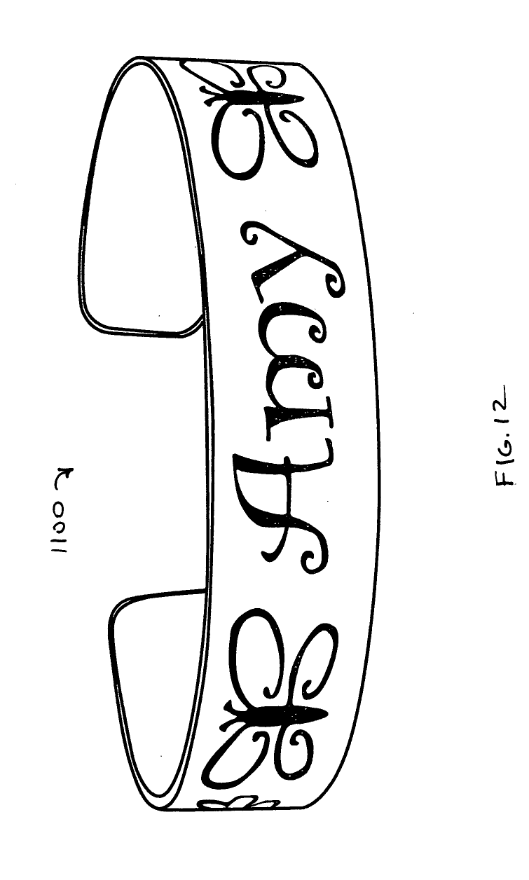

Referring now to FIG. 11, a completed bracelet 1100 is shown in a side view. It will be noted that it has a C-shaped profile.

Referring now to FIG. 12, a completed bracelet 1100 having a pair of Mayflies and the name “Amy” marked thereon is shown in a perspective view.

Although only several embodiments of the invention have been disclosed herein, it will be obvious to those having ordinary skill in the art that changes and modifications may be made thereto without departing from the spirit and scope of the invention as hereinafter claimed.

1. A method of manufacturing an item of jewelry comprising the steps of:
cutting a piece of sheet metal having at least one major planar surface;
coating said at least one major planar surface with a metal marking layer;
subjecting the coated piece of sheet metal to a laser beam, whereby heat generated by the laser beam causes selected regions of the metal marking layer to form a ceramic design that is adhered to said at least one major planar surface;
removing all portions of the marking layer that has not been heated by the laser beam and adhered to said at least one major planar surface;
bending the piece of sheet metal to a desired three-dimensional shape in which said at least one major planar surface becomes curvilinear.

2. The method of claim 1, wherein said laser beam is a component of a computer-controlled, raster-scanning infrared-energy-emitting carbon dioxide (CO₂) laser system that scans in a Y-axis direction and moves in an X-axis direction as it directs energy on the metal-marking-spray-covered at least one major planar surface.

3. The method of claim 2, wherein the coated piece of laminar sheet metal is affixed to a positioning table of said raster-scanning infrared-energy-emitting carbon dioxide CO₂ laser system as it is subjected to the laser beam.

4. The method of claim 1, wherein said piece of sheet metal is selected from the group consisting of stainless steel, aluminum, tin, copper, brass, chromed steel, titanium, niobium, tantalum, silver, gold, palladium, platinum, pewter, and alloys thereof.

5. The method of claim 1, wherein the metal marking layer comprises molybdenum trioxide, at least one vanadium compound, mica group minerals, and crystalline silica.

6. The method of claim 1, wherein the metal marking layer is applied to the piece of sheet metal as an ethanol-based solution by spraying.

7. The method of claim 1, wherein the metal marking layer is selected from the group consisting of LMM-6000, RD-6038, RD-6012, and LMM-5001.

8. A method of manufacturing a bracelet, comprising the steps of:
cutting a laminar metal strip to a desired length and width, said laminar metal strip having first and second parallel, opposed, generally planar major surfaces;
coating at least said first major surface with a metal marking layer;
subjecting the coated piece of sheet metal to a laser beam, whereby heat generated by the laser beam causes selected regions of the metal marking layer to form a ceramic design that is adhered to at least said first major surface;
removing all portions of the marking layer that has not been heated by the laser beam and adhered to at least said first major surface;
bending the metal strip to form a bracelet having a generally C-shaped side profile, and wherein said first and second major planar surfaces are transformed to curvilinear surfaces.

9. The method of claim 8, wherein said laser beam is a component of a computer-controlled, raster-scanning infrared-energy-emitting carbon dioxide (CO₂) laser system that scans in a Y-axis direction and moves in an X-axis direction as it directs energy on a planar major surface of the metal-marking-spray-covered laminar metal strip.

10. The method of claim 9, wherein the coated piece of laminar sheet metal is affixed to a positioning table of said raster-scanning infrared-energy-emitting carbon dioxide CO₂ laser system as it is subjected to the laser beam.

11. The method of claim 8, wherein said laminar metal strip is selected from the group consisting of stainless steel, aluminum, tin, copper, brass, chromed steel, titanium, niobium, tantalum, silver, gold, palladium, platinum, pewter, and alloys thereof.

12. The method of claim 8, wherein the metal marking layer comprises molybdenum trioxide, at least one vanadium compound, mica group minerals, and crystalline silica.

13. The method of claim 8, wherein the metal marking layer is applied to the laminar metal strip as an ethanol-based solution by spraying.

14. The method of claim 8, wherein the metal marking layer is selected from the group consisting of LMM-6000, RD-6038, RD-6012, and LMM-5001.

15. An item of jewelry comprising:
a formed, non-planar laminar metal strip having first and second opposed, generally parallel major surfaces; and
a laser-formed ceramic design adhered to at least one of said major surfaces.

16. The item of jewelry of claim 15, wherein said non-planar laminar metal strip has been formed as a bracelet having a generally C-shaped side profile.

17. The item of jewelry of claim 15, wherein a laser-formed ceramic design is adhered to both of said generally parallel major surfaces.

18. The item of jewelry of claim 15, wherein said laminar metal strip is selected from the group consisting of stainless steel, aluminum, tin, copper, brass, chromed steel, titanium, niobium, tantalum, silver, gold, palladium, platinum, pewter, and alloys thereof.

19. The method of claim 15, wherein the ceramic design molybdenum trioxide, at least one vanadium compound, mica group minerals, and crystalline silica.

20. The method of claim 15, wherein the ceramic design has a thickness within a range of about 10 to 30 microns.
